(19) United States
(12) Patent Application Publication
(10) Pub. No.: US 2016/0146319 A1
(43) Pub. Date: May 26, 2016

(54) NON BACK-DRIVEABLE SCREW MECHANISM

(71) Applicant: AKTIEBOLAGET SKF, Goteborg (SE)

(72) Inventors: Jérôme DUBUS, La Riche (FR); Sébastien LECLUSE, Gruffy (FR); Christian BOCH, Chambery (FR)

(73) Assignee: Aktiebolaget SKF, Göteborg (SE)

(21) Appl. No.: 14/904,126

(22) PCT Filed: Jul. 16, 2013
(86) PCT No.: PCT/EP2013/064983

§ 371 Date: Jan. 11, 2016

(51) Int. Cl. F16H 25/22

(52) U.S. Cl. CPC F16H 25/2252; F16H 25/2266

(57) ABSTRACT

A screw mechanism comprising a screw provided with an outer thread, a nut surrounding and coaxial with the screw, the nut being provided with an inner thread, and a plurality of rolling elements radially disposed between the screw and the nut and engaged in both of the outer and inner threads. A contact diameter D_{contact} between the rolling elements and the nut is defined by:

$${D}_{contact} \geq \frac{L}{π \times tan ( Φ )}$$

wherein L corresponds to the lead of the screw mechanism and Φ corresponds to a determined non-back-driving factor which is chosen from 0°<Φ≦1°. The contact diameter is provided in order to prevent back-driving of the mechanism.

### CROSS REFERENCE TO RELATED APPLICATION

This is a United States National Stage Application claiming the benefit of International Application Number PCT/EP2013/064983 filed on 16 Jul. 2013, which is incorporated herein by reference in its entirety.

### FIELD OF THE INVENTION

The present invention relates to the field of screw mechanisms for transforming a rotary movement into a linear translation movement, and vice versa. More particularly, the invention relates to a non back-driveable screw mechanism.

### BACKGROUND TO THE INVENTION

Roller and ball screw mechanisms are used in a variety of industries for example to displace loads by transforming rotary action into linear motion.

A roller screw mechanism is generally provided with a screw having an outer thread, with a nut arranged around the screw and having an inner thread, and with a plurality of longitudinal rollers having an outer thread engaging the outer and inner threads of the screw and of the nut. The outer thread of each roller is extended axially at each end by gear teeth themselves extended axially by a cylindrical stud or pivot extending outwards.

In a first type of roller screw mechanism, the threads of the rollers and the thread of the nut have helix angles that are identical to each other and different to that of the thread of the screw such that, when the screw rotates in relation to the nut, the rollers rotate on themselves and roll about the screw without moving axially inside the nut. The rollers are rotationally guided by gear wheels mounted in a non-threaded part of the nut and having inner gear teeth meshing with the gear teeth of the rollers. The roller screw mechanism further comprises two end spacer rings each mounted radially between the screw and the associated gear wheel. Each spacer ring includes a plurality of axial through-holes inside which the studs of the rollers are housed. The spacer rings enable the rollers to be carried and the regular circumferential spacing thereof to be kept. Such mechanism is called a standard planetary roller screw.

A second type of roller screw mechanism has a similar operating principle but is different as a result of an inverted arrangement. The helix angles of the threads of the rollers, of the screw and of the nut are selected such that, when the screw rotates in relation to the nut, the rollers rotate on themselves about the screw and move axially in the nut. The rollers are rotationally guided by outer gear teeth provided on the screw and meshing with the gear teeth of the rollers. Two spacer rings are also provided to ensure the even circumferential position of the rollers. Such mechanism is called an inverted planetary roller screw.

It is also known a roller screw mechanism comprising rollers deprived of outer threads but having grooves into which are engaged the outer thread of the screw and the inner thread of the nut. When the screw or nut rotates, the rollers are axially displaced in the nut. After a complete revolution, each roller is returned to its initial position by cams provided at the ends of the nut. Such mechanism is called a recirculating roller screw and may be of the standard or inverted type.

In a ball screw mechanism, the rolling engagement between the screw and the nut is achieved by a plurality of balls engaged into both of the threads provided on the screw and nut. Recirculating means may be provided on the nut to achieve the recirculation of the balls. Such mechanism is called a standard ball screw. Alternatively, recirculating means may be provided on the screw. Such mechanism is called an inverted ball screw. With regard to a ball screw mechanism, the main advantage of a roller screw mechanism is that their admissible static and dynamic load capacities are higher.

The ball and roller screw mechanisms are designed to be reversible or back-driveable under all circumstances. It is therefore necessary to provide an additional brake mechanism, such as a reducer or a brake for instance, if back-driving is to be avoided in the application of the screw mechanism.

For instance, in the field of valve used to control the flow of a fluid, for instance gate valve, control or regulation valve or choke valve, a valve operator assembly is associated to the valve for selectively driving a valve stem up and down. The valve operator assembly generally comprises a screw mechanism to convert the rotational of a hand-wheel into axial motion of the valve stem. Since the screw mechanism is susceptible to back-drive under fluid pressure with the upward force exerted by the fluid, the valve can be inadvertently opened or closed. Such back-driving can not only cause problems with the desired flow regulation, but can also lead to injury to an operator, for example from being struck by the rotating hand-wheel. Accordingly, for a gate valve, a balance system is generally provided on the valve body of the gate valve to prevent these drawbacks. The system may comprise a balance stem disposed on the valve body and which is exposed to fluid pressure to offset or balance the force exerted on the gate.

### SUMMARY OF THE INVENTION

One aim of the present invention is to overcome these drawbacks.

It is a particular object of the present invention to provide a screw mechanism which is not reversible or back-driveable.

It is a further object of the present invention to provide a screw mechanism wherein, for an axial load provided on the screw, the rotation of the nut is automatically prevented.

In one embodiment, the screw mechanism comprises a screw provided with an outer thread, a nut surrounding and coaxial with the screw, the nut being provided with an inner thread, and a plurality of rolling elements radially disposed between the screw and the nut and engaged in both of the outer and inner threads. A contact diameter D_{contact} between the rolling elements and the screw or the nut is defined by:

$${D}_{contact} \geq \frac{L}{π \times tan ( Φ )}$$

with L corresponding to the lead of the screw mechanism, and
with Φ corresponding to a determined non-back-driving factor which is chosen from 0°<Φ≦1°, the contact diameter being provided in order to prevent back-driving of the mechanism.

In one embodiment, the contact diameter is provided between the rolling elements and the nut when the rolling elements are rollers and the rollers axially move together with the screw with respect to the nut. The number of starts of the screw thread or the nut thread may be from 1 to 10, and preferably from 2 to 6, and more particularly from 2 to 4.

In another embodiment, the contact diameter is provided between the rolling elements and the screw when the rolling elements are rollers and the rollers axially move together with the nut with respect to the screw. The number of starts of the screw thread or the nut thread may be from 3 to 10, and preferably from 3 to 8, and more particularly from 4 to 6.

In another embodiment, the contact diameter is provided between the rolling elements and the screw when the rolling elements are rollers and comprises grooves into which are engaged the outer thread of the screw and the inner thread of the nut, the rollers axially moving with respect to the screw and the nut.

In another embodiment, the contact diameter is provided between the rolling elements and the screw when the rolling elements are balls. The number of starts of the screw thread or the nut thread may be from 1 to 4, and preferably equal to 1 or 2, and more particularly equal to 1.

The non-back-driving factor may be chosen from 0°<Φ≦0.5°, and is preferably chosen from 0°<Φ≦0.4°.

The lead of the screw mechanism may be from 0.2 to 20 mm.

In one embodiment, the screw mechanism comprises a screw provided with an outer thread, a nut surrounding and coaxial with the screw, the nut being provided with an inner thread, and a plurality of rolling elements radially disposed between the screw and the nut and engaged in both of the outer and inner threads. A contact diameter D_{contact} between the rolling elements and the screw or the nut is defined by:

$${D}_{contact} \geq \frac{L}{π \times tan ( Φ )}$$

with L corresponding to the lead of the screw mechanism, and
with Φ corresponding to a determined non-back-driving factor which is chosen from 0°<Φ≦1°, wherein the contact diameter is the contact diameter between the rolling elements and the screw, except when the rolling elements are rollers and the rollers move together with the screw with respect to the nut the contact diameter being then the contact diameter between the rollers and the nut.

The invention also relates to an actuator comprising a rotating means and a screw mechanism as previously defined, the screw of the mechanism being coupled with the rotating means.

### BRIEF DESCRIPTION OF THE DRAWINGS

The present invention and its advantages will be better understood by studying the detailed description of a specific embodiment given by way of a non-limiting example and illustrated by the appended drawings on which:

FIG. 1 is a cross-section of a valve operator assembly for gate valve according to an example of the invention; and

FIG. 2 is a cross-section of an inverted roller screw mechanism of the assembly of FIG. 1.

### DETAILED DESCRIPTION OF THE PRESENT INVENTION

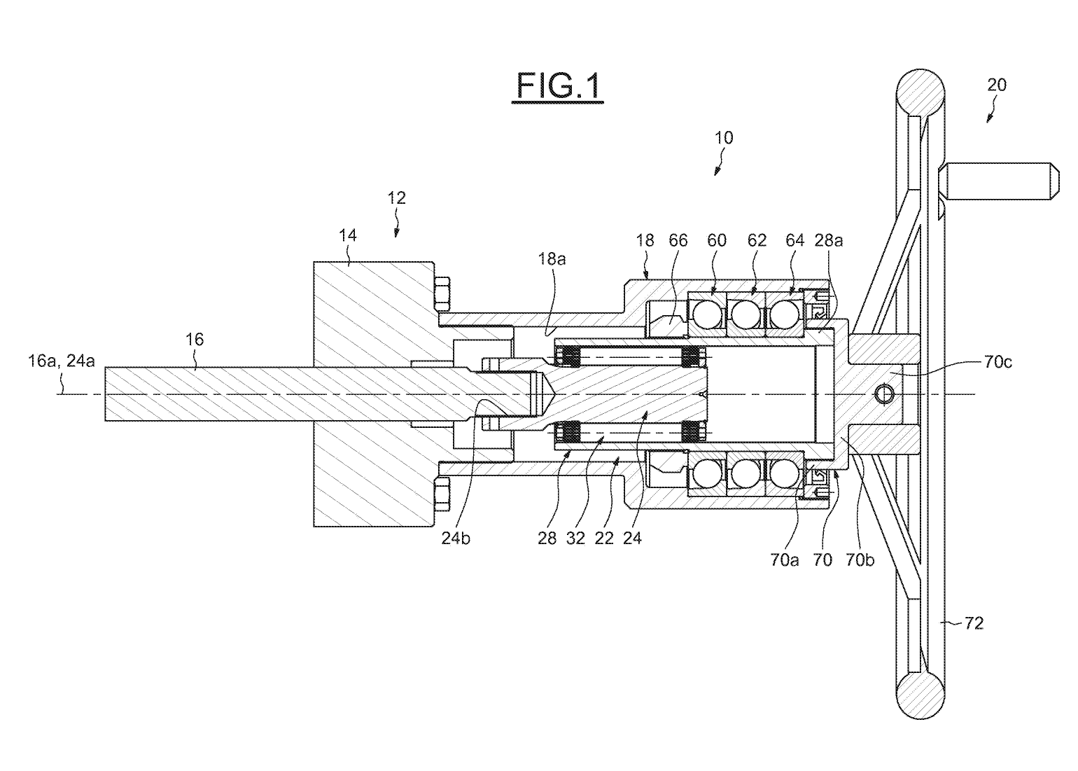

A valve operator assembly 10 as shown on FIG. 1 is adapted for a gate valve 12 provided with a bonnet 14, a valve body (not shown) covered by the bonnet and a moveable valve stem 16 with an axis 16a. Conventionally, the valve body has a longitudinal flow bore and a transverse gate cavity that intersects the flow bore. The gate valve also comprises a gate having a gate opening extending transversely therethrough is disposed in the gate cavity. For more detail on such a gate valve, it could be referred to EP-B1-1 419 334 (SKF) which is hereby incorporated by reference.

The valve operator assembly 10 comprises a tubular housing 18 mounted on the bonnet 14 of the gate valve, an input member 20 rotatably mounted with respect to the housing, and an inverted roller screw mechanism 22 interposed between the input member and the valve stem 16 of the valve to convert a rotation of the input member 20 into an axial translation of the valve stem. The inverted roller screw mechanism 22 is mounted into a bore 18a of the housing and is connected to the input member 20. One axial end of the housing 18 is secured to the bonnet 14 by threads (not referenced). In the illustrated example, the bore 18a has a stepped form.

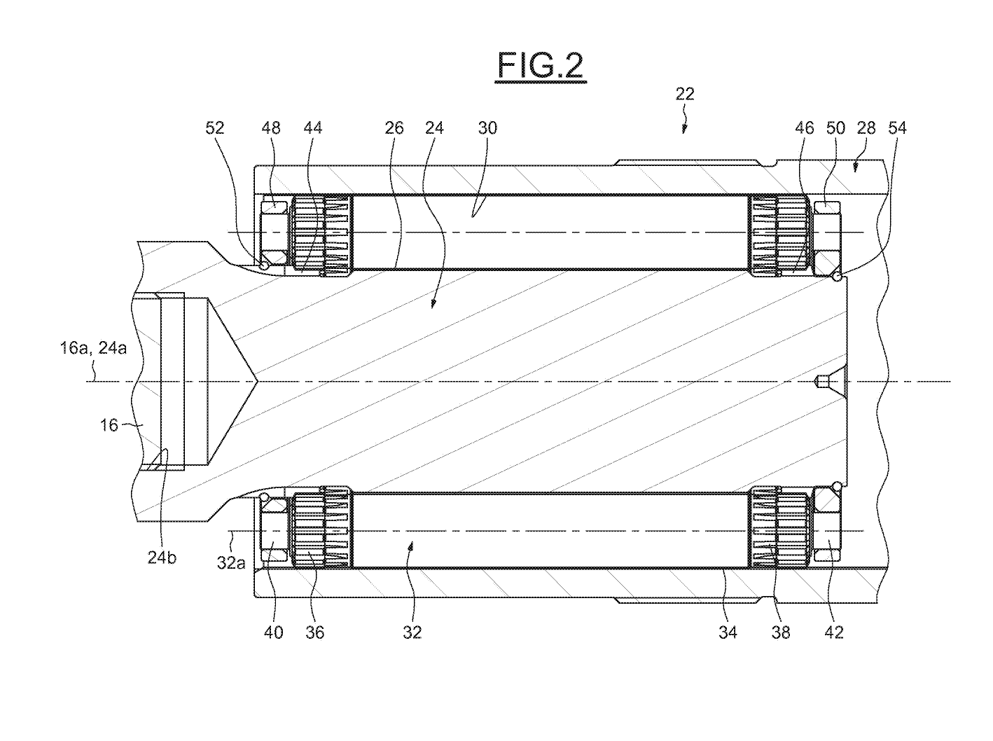

As shown more clearly on FIG. 2, the mechanism 22 comprises a screw 24, with an axis 24a coaxial with the axis 16a of the valve stem 16, provided with an outer thread 26, a nut 28 mounted coaxially about the screw 24 and provided with an inner thread 30, the internal diameter of which is greater than the external diameter of the outer thread 26, and a plurality of longitudinal rollers 32 arranged radially between the screw 24 and the nut 28. The screw 12 extends longitudinally through a cylindrical bore of the nut 28 on which the inner thread 30 is formed. The nut 28 has a tubular form and is elongated to accommodate the full extent of screw travel. Axially on the side opposite to the input member 20 (FIG. 1), a recess 24b is formed on a frontal radial surface of the screw 12 and into which is fixed an end of the valve stem 16 of the gate valve. The valve stem 16 is connected to the screw 24 by any appropriate means, for example by threads and/or a pin.

The rollers 32 are identical to each other and are distributed regularly around the screw 24. Each roller 32 extends along an axis 32a which is coaxial with the axis 24a of the screw and comprises an outer thread 34 engaging the thread 26 of the screw and the thread 30 of the nut. Each roller 20 also comprises, at each axial end, outer gear teeth 36, 38 extending axially outwards the outer thread 34 and which are themselves extended axially by a cylindrical stud 40, 42 extending outwards. Each gear teeth 36, 38 are axially located between the associated stud 40, 42 and the outer thread 34. The outer thread 34 of each roller is axially located between the two gear teeth 36, 38.

The roller screw mechanism 22 also comprises two annular gear wheels 44, 46 provided on the outer surface of the screw 24 and each comprising outer gear teeth meshing the gear teeth 36, 38 respectively of the rollers 32 for the synchronization thereof. Each gear wheel 44, 46 is axially located near to an end of the outer thread 26 of the screw. The outer thread 26 is axially located between the two gear wheels 44, 46. In the disclosed embodiment, the gear wheels 44, 46 are formed directly on the outer surface of the screw 24. Alternatively, the gear wheels may be separate parts which are fixed onto the screw 24.

The mechanism 22 further comprises two annular guides or spacer rings 48, 50 disposed on the outer surface of the screw 24. The spacer rings 48, 50 are radially disposed between the screw 24 and the inner thread 30 of the nut without contact with the thread. Each spacer ring 48, 50 is mounted on the outer surface of the screw 24 axially next to the associated gear wheel 44, 46. Each spacer ring 48, 50 is axially offset towards the outside of the nut 28 with regard to the associated gear wheel 44, 46. Each spacer ring 48, 50 comprises a plurality of cylindrical through-recesses (not referenced) which are distributed regularly in the circumferential direction and inside which the studs 40, 42 of the rollers are housed. The spacer rings 48, 50 enable the rollers 32 to be carried and the regular circumferential spacing thereof to be kept. The mechanism 22 further comprises elastic retainer rings 52, 54 each mounted in a groove (not referenced) formed on the outer surface of the screw 24 in order to axially hold the corresponding spacer ring 48, 50.

Referring once again to FIG. 1, the valve operator assembly 10 further comprises rolling bearings 60 to 64 to guide the rotation of the nut 28 of the inverted roller screw mechanism. The rolling bearings 60 to 64 are radially mounted between the outer surface of the nut 28 and the stepped bore 18a of the housing. The rolling bearings 60 to 64 are mounted radially in contact with the outer surface of the nut 28 and a large diameter portion of the stepped bore 18a of the housing. In the disclosed example, the rolling bearings 60 to 64 are angular contact thrust ball bearings and are disposed axially in contact one to another. A retaining ring 66 is secured on the outer surface of the nut 28 and axially bears against the rolling bearing 60. Axially on the opposite side, the rolling bearing 64 is axially mounted against a flange 28a of the nut 28 extending radially outwards the outer surface of the nut. The flange 28a is axially located at an axial end of the nut.

The input member 20 comprises an adapter sleeve 70 mounted on the nut 28 and a hand-wheel 72 secured to the sleeve. The sleeve 70 comprises an annular axial portion 70a secured to the flange 28a of the nut by any appropriate means, for example by threads, a radial portion 70b extending radially inwards the axial portion 70a and bearing axially against the end of the nut, and a pin 70c projecting axially outwards from the radial portion 70b and onto which is secured the hand-wheel 72. Sealing means (not referenced) are provided between the axial portion 70a of the sleeve and the bore of the housing 18.

When an operator applies a torque on the hand-wheel 72, this torque is transmitted to the adapter sleeve 70 and then to the nut 28 of the inverted roller screw mechanism. With the rotation of the nut 28, the rollers 32 rotate on themselves about the screw 24 and move axially and additionally rotate in the nut 28. The rollers 32 are rotationally guided by outer gear wheels 44, 46 provided on the screw and meshing with the gear teeth of the rollers. Both the rollers 32 and the screw 12 are axially or longitudinally moveable into the nut 28. Accordingly, the rotational motion of a hand-wheel 72 is converted into an axial motion of the valve stem 16 of the valve gate.

In order to avoid back-drive of the inverted roller screw mechanism 22 under fluid pressure on the valve gate, the contact diameter D_{contact} between the rollers 32 and the nut 28 in mm is advantageously defined by:

$${D}_{contact} \geq \frac{L}{π \times tan ( Φ )}$$

with L corresponding to the lead of the inverted roller screw mechanism, and
with Φ corresponding to a determined non-back-driving factor which is chosen from 0°<Φ≦1°. The lead is the axial travel per turn. The contact diameter is equal to the diameter on thread flanks of the nut where rollers 32 are in contact.

With such a contact diameter D_{contact} between the rollers 32 and the nut 28, the indirect efficiency of the inverted roller screw mechanism 22 equals zero or is very close to zero. The indirect efficiency defines the axial load required to transform the translation of the screw 24 into a rotation of the nut 28. The mechanism 22 is not reversible even with an optimal and minimum internal friction created into the mechanism and/or into the assembly.

As previously indicated the non-back-driving factor Φ is greater than 0° and less than or equal to 1°. With a non-back-driving factor Φ less than or equal to 0.4°, the prevention of the back-driving of the inverted roller screw mechanism 22 is guaranteed. Accordingly, under fluid pressure exerted both on the valve stem 16 and the screw 24, the mechanism 22 is not reversible or back-driveable. The force exerted by the fluid is not transformed into a rotation of the nut 28.

With a non-back-driving factor Φ greater than 0.4° and less than or equal to 0.5°, the indirect efficiency of the inverted roller screw mechanism 22 is very close to zero and the prevention of the back-driving of the inverted roller screw mechanism 22 is obtained with the internal friction created into the mechanism which generates a braking torque preventing the rotation of the nut 28 under an axial load exerted by the fluid on the screw 24. With a non-back-driving factor Φ greater than 0.5° and less than or equal to 1°, the prevention of the back-driving of the inverted roller screw mechanism 22 may also obtained with the internal friction created into the mechanism and/or into the assembly 10.

Thanks to the contact diameter D_{contact} as previously defined, it is possible to not foresee a balance system, such as a balance stem, on the valve body of the gate valve to avoid back-driving of the mechanism 22.

Preferably, for a valve operator assembly 10 used with a surface valve gate and with a subsea valve gate, the lead of the inverted roller screw mechanism 22 may be respectively from 2 to 6 mm, and from 2 to 20 mm. The number of starts of the screw thread may be advantageously from 1 to 5 and preferably equal to 3. Preferably, the number of starts of the nut thread is equal to the one of the screw thread. Preferably, the outer thread of each roller 36 has only one start.

The contact diameter d_{contact} between the rollers 32 and the screw 24 in mm is advantageously defined by:

$${d}_{contact} \geq \frac{N \times L}{[ ( N + 2 ) \times \times tan ( Φ ) ]}$$

with N corresponding to the number of starts of the screw thread,
with L corresponding to the lead of the inverted roller screw mechanism in mm, and
with Φ corresponding to the determined non-back-driving factor. The contact diameter is equal to the diameter on thread flanks of the screw where rollers 32 are in contact.

The invention has been illustrated on the basis of a valve operator assembly for gate valve comprising an inverted roller screw mechanism having a screw connected to the valve stem of the gate valve and a nut connected to the input member. Alternatively, the screw may be connected to the input member and the nut connected to the valve stem. The valve operator assembly may also be used with other valves, such as control or regulation valves or choke valves. Such an inverted roller screw mechanism as disclosed can also be used in other applications for which back-driving is to be avoided for example such as lifts, elevators, tables, jacking systems, etc. In this case, the contact diameter D_{contact} between the rollers and the nut and the contact diameter d_{contact} between the rollers and the screw are the same that the one as previously defined. The lead of the inverted roller screw mechanism may be for instance from 0.5 to 20 mm. The number of starts of the screw thread may be advantageously from 1 to 10, and preferably from 2 to 6, and more particularly from 2 to 4. Preferably, the number of starts of the nut thread is equal to the one of the screw thread. Preferably, the outer thread of each roller 36 may have only one start.

The invention can also be applied to other type of roller screw mechanism such as standard planetary roller screw mechanism wherein the rollers axially move together with the nut with respect to the screw, or standard recirculating roller screw mechanism or inverted recirculating roller screw mechanism wherein the rollers comprises grooves into which are engaged the threads of the screw and the nut and axially move with respect to the screw and nut. In these three cases, the contact diameter D_{contact} as previously defined is provided between the rollers and the screw rather than between the rollers and the nut. In these roller screw mechanisms, to prevent back-driving, the contact diameter D_{contact} between the rollers and the screw is defined by:

$${D}_{contact} \geq \frac{L}{π \times tan ( Φ )}$$

with L corresponding to the lead of the mechanism, and
with Φ corresponding to the determined non-back-driving factor as previously defined. For instance, for a standard planetary roller screw mechanism, the lead may be from 0.6 to 20 mm. The number of starts of the screw thread may be advantageously from 3 to 10, and preferably from 3 to 8, and more particularly from 4 to 6. Preferably, the number of starts of the nut thread is equal to the one of the screw thread. Preferably, the outer thread of each roller 36 may have only one start.

The invention can also be applied to standard or inverted ball screw mechanisms. For such a ball screw mechanism, the contact diameter D_{contact} is provided between the balls and the screw. To prevent back-driving of the standard or inverted ball screw mechanism, the contact diameter D_{contact} between the balls and the screw is defined by:

$${D}_{contact} \geq \frac{L}{π \times tan ( Φ )}$$

with L corresponding to the lead of the mechanism, and
with Φ corresponding to the determined non-back-driving factor as previously defined. For instance, for a standard or an inverted ball screw mechanism, the lead may be from 0.2 to 20 mm. The number of starts of the screw thread may be advantageously from 1 to 4, and preferably equal to 1 or 2, and more particularly equal to 1. Preferably, the number of starts of the nut thread is equal to the one of the screw thread.

Thanks to the use of a contact diameter D_{contact} as previously defined, the screw mechanism is not reversible or back-driveable without additional mechanism such as brake. Besides, the required torque for moving the screw towards the input member is reduced with the indirect efficiency of the mechanism which equals or is very close to zero. Although the invention has been illustrated on the basis of a screw mechanism having a rotating nut and a translating screw, it should be understood that the invention can be applied with a rotating screw and a translating nut.

1. A screw mechanism comprising:
a screw provided with an outer thread,
a nut surrounding and coaxial with the screw, the nut being provided with an inner thread, and
a plurality of rolling elements radially disposed between the screw and the nut and engaged in both of the outer and inner threads,
wherein a contact diameter (D_{contact}) between the rolling elements and one of the screw or the nut is defined by:
$${D}_{contact} \geq \frac{L}{π \times tan ( Φ )}$$
wherein L corresponds to the lead of the screw mechanism, and
wherein Φ corresponds to a determined non-back-driving factor that is chosen from 0°<Φ≦1°,
wherein the contact diameter is provided in order to prevent back-driving of the mechanism.

2. The screw mechanism according to claim 1, wherein the contact diameter is provided between the rolling elements and the nut when the rolling elements are rollers and the rollers axially move together with the screw with respect to the nut.

3. The screw mechanism according to claim 2, wherein the number of starts of one of the screw thread or the nut thread is from 1 to 10.

4. The screw mechanism according to claim 1, wherein the contact diameter is provided between the rolling elements and the screw when the rolling elements are rollers and the rollers axially move together with the nut with respect to the screw.

5. The screw mechanism according to claim 4, wherein the number of starts of the screw thread or the nut thread is from 3 to 10.

6. The screw mechanism according to claim 1, wherein the contact diameter is provided between the rolling elements and the screw when the rolling elements are rollers and comprises grooves into which are engaged the outer thread of the screw and the inner thread of the nut, the rollers axially moving with respect to the screw and the nut.

7. The screw mechanism according to claim 1, wherein the contact diameter is provided between the rolling elements and the screw when the rolling elements are balls.

8. The screw mechanism according to claim 7, wherein the number of starts of the screw thread or the nut thread is from 1 to 4.

9. The screw mechanism according claim 1, wherein the non-back-driving factor is chosen from 0°<Φ≦0.5°.

10. The screw mechanism according to claim 6, wherein the non-back-driving factor is chosen from 0°<Φ≦0.4°.

11. The screw mechanism according to claim 1, wherein the lead (L) of the screw mechanism is from 0.2 to 20 mm.

12. An actuator comprising a rotating device and a screw mechanism, the screw mechanism comprising:
a screw provided with an outer thread,
a nut surrounding and coaxial with the screw, the nut being provided with an inner thread, and
a plurality of rolling elements radially disposed between the screw and the nut and engaged in both of the outer and inner threads,
wherein a contact diameter (D_{contact}) between the rolling elements and one of the screw or the nut is defined by:
$${D}_{contact} \geq \frac{L}{π \times tan ( Φ )}$$
wherein L corresponds to the lead of the screw mechanism, and
wherein Φ corresponds to a determined non-back-driving factor that is chosen from 0°<Φ≦1°,
wherein the contact diameter is provided in order to prevent back-driving of the mechanism,
wherein the screw of the mechanism are coupled with the rotating device.

13. The screw mechanism according to claim 2, wherein the number of starts of one of the screw thread or the nut thread is from 2 to 6.

14. The screw mechanism according to claim 2, wherein the number of starts of one of the screw thread or the nut thread is from 2 to 4.

15. The screw mechanism according to claim 4, wherein the number of starts of the screw thread or the nut thread is from 3 to 8.

16. The screw mechanism according to claim 4, wherein the number of starts of the screw thread or the nut thread is from 4 to 6.

17. The screw mechanism according to claim 7, wherein the number of starts of the screw thread or the nut thread is from 1 to 2.

18. The screw mechanism according to claim 7, wherein the number of starts of the screw thread or the nut thread is equal to 1.
